(19) United States
(12) Patent Application Publication
(10) Pub. No.: US 2014/0353306 A1
(43) Pub. Date: Dec. 4, 2014

(54) Thermal Containers

(71) Applicant: Michael Martin Cleary, Longmont, CO (US)

(72) Inventor: Michael Martin Cleary, Longmont, CO (US)

(73) Assignee: CLEARY'S FOOD AND BEVARAGE CONTAINERS, Longmont, CO (US)

(21) Appl. No.: 14/214,532

(22) Filed: Mar. 14, 2014

Related U.S. Application Data
(60) Provisional application No. 61/801,295, filed on Mar. 15, 2013.

(51) Int. Cl. A47J 36/24; B65D 81/34

(52) U.S. Cl. CPC A47J 36/2494; B65D 81/34
USPC 219/730

(57) ABSTRACT

A container to keep substances heated for longer periods of time is described. The container bears a cavity that contains a heating medium and a microwave susceptor. The container maybe a plate, cup, mug or other utensil to keep food or bevarages hot.

### CROSS REFERENCE TO RELATED APPLICATIONS

This application claims the benefit of U.S. Provisional Application No. 61/801,295 filed on 15 Mar. 2013 entitled “Thermal Containers” which is incorporated herein in its entirety.

### BACKGROUND OF THE INVENTION

Food served at commercial, domestic and other settings tends to cool down fast if it is not consumed quickly leading to less than optimal taste and enjoyment of some flavors. A need exists for containers that will keep food at a higher temperature for longer periods of time. The present invention provides a solution to this problem.

### SUMMARY OF THE INVENTION

One aspect of the current invention is a double walled food container with a cavity in the wall containing a heating medium and a material such as a microwave susceptor that absorbs heat from a microwave radiation which is stored in a medium and released to keep food at elevated temperatures for longer periods of time. One aspect of the current invention is a double walled food container with the cavity in the wall containing a heating medium that absorbs heat which is released to keep food at elevated temperatures for longer periods of time.

### DETAILED DESCRIPTION OF THE INVENTION

The following embodiments, aspects and variations thereof are exemplary and illustrative and are not intended to be limiting in scope.

In one aspect, there is provided a container which is double walled containing a microwave susceptor and a heating medium within cavity of said double wall.

In one aspect there is provided a double walled stoneware container with a microwave susceptor in a heating medium such as mineral oil.

In one aspect there is provided a double walled polyurethane container with a silica gel susceptor in a heating medium such as mineral oil. In one aspect there is provided a double walled acrylic container with a microwave susceptor in a heating medium such as mineral oil. In one aspect there is provided a double walled glass container with a microwave susceptor in a heating medium such as mineral oil. In one aspect there is provided a double walled stoneware container with a microwave susceptor in a heating medium such as mineral oil.

In one aspect there is provided a double walled ceramic container with silica gel and mineral oil medium within cavity of said double wall.

In one aspect there is provided a container comprising a double walled metal container with a silica gel and mineral oil medium within cavity of said double wall.

In one aspect there is provided a container comprising a double walled metal container with a heating medium within cavity of said double wall which is heated by a other means such as a traditional oven, convectional, heating lamp, dishwasher, plate warmer and the like used to heat containers in domestic, restaurant, hospital and other commercial and non-commercial uses. The double walled container may be made from material such as porcelain, ceramic, glass, stoneware, synthetic polymers such as polypropylene, acrylic, polyoxymethylene, acetal, polyacetal, polyformaldehyde known commercially as Delrin, Celcon, Hostaform, and the like, metal or natural polymers such as cellulose and the like.

In one aspect there is provided a container comprising a double walled earthanware container with a microwave susceptor and mineral oil medium within cavity of said double wall.

In one aspect there is provided a container comprising a double walled container with a heating medium containing a microwave susceptor selected from the group consisting of silica gel, clay, silicon carbide, titanium oxide, SiC-coated alumina, magnesium oxide (MgO) coated alumina, SiC coated quartz, porcelain chips and MgO coated quartz.

In one aspect there is provided a container comprising a double walled container with a microwave susceptor containing a medium selected from the group consisting of mineral oil, water, an aqueous salt solution, a methyl cellulose gel, animal fat, plant based fat, petroleum based hydrocarbon, glycerol, xylitol and other high boiling alcohol.

In various aspects the ratio of heating medium to microwave susceptor are in the ratios of 100:1 to 1:100. Preferred ratios are from 1:10 to 10:1. More preferred ratios are 1:1, 1:2, 1:3, 1:4, 1:5, 1:6 for susceptor to heating medium respectively.

In one aspect there is provided a container that is a dinner plate, cup, mug, a quarter plate, a bowl, a serving dish, a basin, tray, platter or like utensil used to keep food or liquids warm. In one aspect said dinner plate, cup, mug, a quarter plate, a bowl, a serving dish, a basin, tray, platter or like utensil used to keep food or liquids warm has a double wall that contains a microwave susceptor that absorbs heat energy and releases it so the contents held within the container are kept warm longer.

In one aspect there is provided a container that is a dinner plate, cup, mug, a quarter plate, a bowl, a serving dish, a basin, tray, platter or like utensil with a microwave susceptor and heating medium distributed within the wall. In another aspect the microwave susceptor such as silica gel is melted into the container material which my be a polymer such as polypropylene, polyethylene, polyoxymethylene, acetal, polyacetal, polyformaldehyde known commercially as Delrin, Celcon, Hostaform, etc. or other high melting polymer fused with a a susceptor such as silica or the like.

In one aspect the container contains a microwave susceptor for heating with a microwave oven.

In another aspect the container may be heated by other means such as a stove, oven, chef's torch or like heating means.

In one aspect the container is insulated on the surface in contact the surface on which it rests.

In one aspect the container bears a surface in contact with food which conducts heat from the heated internal medium to contents to keep them warm.

In one aspect the container is double walled made of polyoxymethylene, acetal, polyacetal, polyformaldehyde known commercially as Delrin, Celcon, Hostaform, etc.

In one aspect the container bears a cavity containing a heating medium and no susceptor as the heating medium itself absorbs microwave radiation.

A microwave susceptor is a material that absorbs electromagnetic energy and converts it into heat or reemits it as infrared waves. Suceptors are used in microwave heating.

In order to test the ability of a heating medium to stay warm, experiments were conducted where a susceptor was mixed with a medium and the two heated in a microwave oven. Temperature after heating was measured and time taken for the mixture to cool down was noted. Different ratios of susceptor and medium were tested. Silica gel and mineral oil in a 1:0.25 ratio were tested by heating in a microwave oven for three minutes. Temperature was 217 F and the mixture was allowed to stand. After 23 minutes temperature was at 160° F.

The experiment was repeated by heating the silica/mineral oil mixture described above to 330° F. and allowing to stand. After 62 minutes temperature was 118 F.

The experiment was repeated by heating silica gel/mineral oil mixture in microwave for 7 minutes in a paper cup when temperature was 388° F. After standing for 58 minutes the temperature was 136 F.

Experiments were also conducted with glycerol. ½ cup of silica sand and ½ cup of mineral oil for 3 minutes. The temperature reached 309 degree F. ˜1 hour later the temperature went down to 101 degrees F.

Heated ½ cup of mineral oil and ½ cup of vegetable glycerine for 3 minutes the temperature was 409 degree F. ˜1 hour later the temperature was 146 degrees.

Heated ½ cup of vegetable glycerine and a ½ cup of silica for 3 minutes. The temperature reached 417 degrees F. an hour later the temperature was 160 F.

20 oz of spegetitos was placed in a ceranmic plate with a hollow cavity containing ¼ cup silica sand. 20 oz spegetiots was poured onto the plate and heated in a microwave for 2 minutes to 160° F. and allowed to stand. After 30 minutes the temperature of the food measured 100° F.

¼ cup silica sand was placed in a ceramic plate with a hollow cavity, 1 cup clam chowder was added to the plate and the clam chowder was heated for 3 minutes in a microwave oven to 196° F. and allowed to stand. After 30 minutes the temperature was 94.0° F.

A bowl made of polyethylene plastic layers with a mixture containing ½ Cup of silica and ½ cup mineral oil melted between the layers was filled with 1 cup of water and heated to 184.4° F. in 3.5 minutes in a microwave oven and allowed to stand. After 30 minutes the temperature was 87.1° F.

A bowl made of polyethylene plastic layers with a mixture containing 1 Cup of silica melted between the layers was filled with 1 cup of water and heated to 193.0° F. in 3.5 minutes in a microwave oven and allowed to stand. After 30 minutes the temperature was 96.1° F.

Pyrex Cup (measuring cup) containing ½ Cup of silica was heated in a microwave for 3.5 minutes to a temperature of 251.5° F. and allowed to stand. After 40 minutes the temperature was 124.1° F.

Pyrex Cup (measuring cup) containing ½ Cup of silica and ½ cup mineral oil was heated in a microwave for 3.5 minutes to 63.3° F. After 30 minutes the temperature was 115.0° F.

What is claimed is:

1. A container to keep a substance warm with walls of said container bearing a cavity comprising:
a) A heating medium contained in said cavity; and,
b) A susceptor to absorb and heat said heating medium.

2. A container of claim 1 where said container is selected from a group consisting of a plate, cup, bowl, mug, platter, serving dish or basin.

3. A container of claim 1 where material of said container is selected from the group consisting of a plastic, metal, ceramic, clay, natural polymer, organic or inorganic material.

4. A container of claim 3 where material of said container is a polyacetal polymer.

5. A container of claim 1 where said microwave susceptor is selected from the group consisting of silica gel, silicon carbide, titanium oxide, SiC-coated alumina, magnesium oxide (MgO) coated alumina, SiC coated quartz, clay and MgO coated quartz.

6. A container of claim 1 where said medium is selected from the group consisting of mineral oil, water, an aqueous salt solution, a methyl cellulose gel, animal fat, plant based fat, glycerol, xylitol and other high boiling alcohol.

7. A container of claim 1 where:
a) Said container is made from polyacetal polymer, Delrin,
b) Said heating medium is mineral oil; and,
c) Said microwave susceptor is silica gel.

8. The container of claim 1 where the heating medium is mineral oil and the microwave susceptor is clay.

9. The container of claim 1 where the heating medium is clay.

10. A food container to keep food warm comprising a polymer material with a microwave susceptor fused into the container material.

11. The container of claim 10 where the microwave susceptor is selected from the group consisting of silica gel, silicon carbide, titanium oxide, SiC-coated alumina, magnesium oxide (MgO) coated alumina, SiC coated quartz, clay and MgO coated quartz.

12. The container of claim 10 where the microwave susceptor is silica gel.

13. The container of claim 10 where the microwave susceptor is silica gel and the polymer material of the food container is poly propylene.

14. The container of claim 10 where the microwave susceptor is silica gel and the polymer material of the food container is polyoxymethylene, acetal, polyacetal, polyformaldehyde such as Delrin.
